(19) United States
(12) Patent Application Publication
(10) Pub. No.: US 2020/0027167 A1
(43) Pub. Date: Jan. 23, 2020

(54) REAL TIME VERIFICATION OF VEHICLE INSURANCE COVERAGE

(71) Applicants: Jeno Harris, Toledo, OH (US); Brandon Hunter, Toledo, OH (US)

(72) Inventors: Jeno Harris, Toledo, OH (US); Brandon Hunter, Toledo, OH (US)

(21) Appl. No.: 16/516,498

(22) Filed: Jul. 19, 2019

Related U.S. Application Data
(60) Provisional application No. 62/701,087, filed on Jul. 20, 2018.

(51) Int. Cl. G06Q 40/08; B42D 25/23; B42D 25/455; G06K 19/04; G06K 19/06

(52) U.S. Cl. CPC G06Q 40/08; B42D 25/23; G06K 19/06028; G06K 19/044; B42D 25/455

(57) ABSTRACT

The Carence embodiments demonstrate a new innovative way to provide “Real Time” vehicle insurance coverage. A plastic insurance card including a security chip provides “Real Time” reporting of ACTIVE or INACTIVE insurance coverage.

### CROSS REFERENCE TO RELATED APPLICATION

The present patent application is based upon and claims the benefit of provisional patent application No. 62/701,087 filed on Jul. 20, 2018.

### FIELD OF THE INVENTION

This invention relates to systems, methods and apparatus for verifying vehicle insurance coverage.

### BACKGROUND OF THE INVENTION

Vehicle owners are required by law to carry proof of insurance in states such as Ohio. The proof of insurance usually is in the form of a paper insurance card issued by an insurance provider that is underwriting the insurance coverage. The insurance card may identify the name and address of the vehicle owner, the name of the insurance provider, the policy number, the effective date and the expiration date of the insurance coverage, the vehicle make, the vehicle model, and the vehicle identification number (VIN).

A new insurance card is typically issued by an insurance provider each time a vehicle owner obtains a new insurance policy or renews existing policy. However, it is not uncommon for an owner to forget to place the insurance card in the vehicle or to replace the expired insurance card with the new insurance card. As a result, if the owner is subsequently stopped by a law enforcement officer, the owner may not be able to produce valid proof of insurance.

In addition, a vehicle owner may renew his or her insurance policy by paying only a portion of the insurance premiums but may stop making payments upon receiving a new insurance card, thereby causing the policy to lapse before its official expiration date. The owner may, nonetheless, present the insurance car as proof of “current” insurance coverage.

This type of fraud, unfortunately, occurs often. This places a burden on a person injured by an uninsured driver that does not have insurance coverage.

### SUMMARY OF THE INVENTION

As a result, the present invention for verifying, in real time, current vehicle insurance coverage will be an asset to a community. The Carence System is a new and innovative way of enforcing the law found in the Ohio Revised Code section 4509.101 Operating of motor vehicle without proof of financial responsibility. In section (A) (1) No person shall operate, or permit the operation of, a motor vehicle in this state, unless proof of financial responsibility is maintained continuously throughout the registration period with respect to that vehicle, or, in the case of a driver who is not the owner, with respect to that driver's operation of that vehicle.

The Carence system is a new innovative method that allows law enforcement officers to more effectively perform a routine traffic stop. The driver of the vehicle will submit to law enforcement officers upon request their insurance issued PVC/chipped magnetic insurance card. The officer will return to their cruiser and swipe the card or insert the chipped PVC card into a card reader. The reader will gather information in “Real Time” reporting ACTIVE or INACTIVE. The officer will now be able to perform his/her duties by completing a better accurate citation report. The citation is then submitted to traffic court and the judge can now render a punishment or fines more effectively.

The current method of providing proof of the insured motorist is via a paper copy and visual digital proof via a smart device. This has been the standard method since the law went into effect. This method has been proven less effective for decades resulting in loss of revenues. With improving technology, it has become easier to falsify proof of insurance.

### BRIEF DESCRIPTION OF THE DRAWINGS

FIG. 1 is an illustration of a PVC Issued Insurance Card, according to this invention.

FIG. 2 is an illustration of a prior art paper Issued Insurance Card.

FIG. 3 is an illustration of a prior art False Insurance Card.

FIG. 4 shows embodiments wherein various codes are included on the Insurance Card of FIG. 1.

### DETAILED DESCRIPTION OF THE INVENTION

The following embodiments demonstrate that the Carence system is a new innovative way to provide information in “Real Time” by reporting ACTIVE or INACTIVE insurance coverage.

Carence Strengths:
Increased revenue for stronger economy
Increase in new policy holders
Longer lasting policies
Reduced fatalities involving noninsured motorist
Increase in public transportation use
Equality
Reduction in emissions
Low implementation cost
Harder to fraud for most individuals
Accurate citation reporting
Real time reporting

Carence Weakness:
Hackers may still find a way to create fraudulent cards.

Current Method Strengths:
No Strengths identified

Current Method Weaknesses:
Easy to fraud paper copy
Obtain policy for proof then cancel
Easily damaged or destroy
Law enforcement officers have no way of knowing if the insurance is active
Law enforcement officers issue inaccurate citations
Creates Inequality
Loss of revenues for both Government/Insurance companies
Loss of tax on revenues for government

Beneficiaries of the Carence System
Government—City, State, and Federal levels with an increase in revenue through financial penalties, higher tax revenue from insurance companies do to increased policy revenue
Environmentalist—reduced emissions with less vehicles on the road
Insurance Companies—increase in policy holders/Revenues
Taxpayers—creating equality
Citizens—better economy

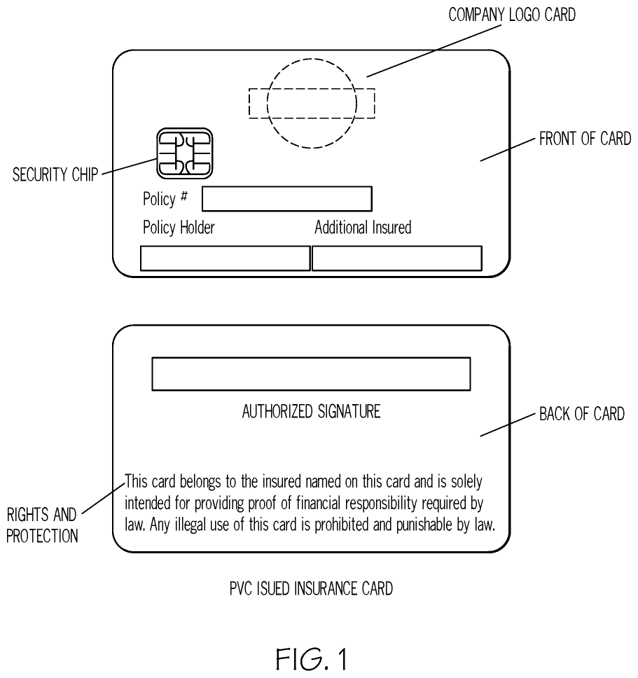

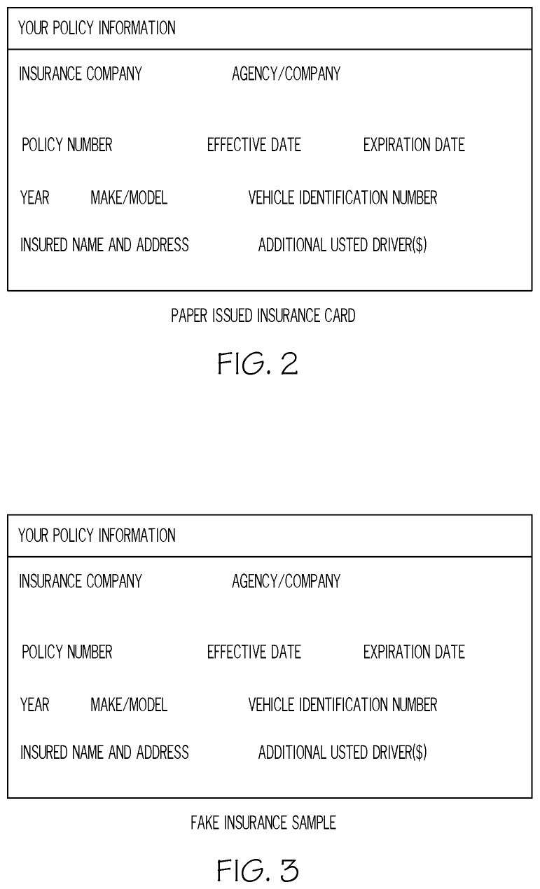

FIG. 1 is an illustration of a PVC Issues Insurance Card, according to this invention. The insurance card provides real time insurance coverage for the Carence strengths of this invention. In one embodiment, FIG. 1 shoes a security chip as part of the card of this invention.

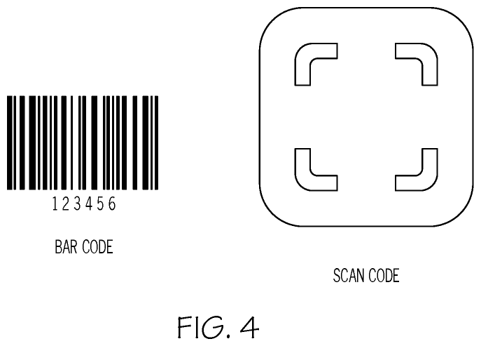

FIG. 4 shoes other embodiments of various codes or security devices that may be included in the insurance Card of this invention. FIG. 4 shows a bar code or scan code that may be incorporated into the card. A magnetic strip is another embodiment that may be used.

This invention is carried out with hardware, software, or both. The system, methods and apparatus of the disclosed embodiments, may take the form of program code (i.e., instructions) embodied in tangible media, such as floppy diskettes, CD-ROMS, hard drives, or any other machine-read-able storage medium, wherein, when the program code is loaded into and executed by a machine, such as a computer, the machine becomes an apparatus for practicing one or more of the disclosed embodiments. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object-oriented programming language to communicate with a computer system. However, the program(s) can be implemented in assembly or machine language, if desired. In any case, the language may be complied or interpreted language, and combined with hardware implementations.

The described systems, methods and apparatus may also be embodied in the form of program ode that is transmitted over some transmission medium, such as over electrical wiring or cabling, though fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing one or more of the disclosed embodiments. When implemented on a general-purpose processor, the program code combines with the processor to provide a unique apparatus that operates to perform the processing of one or more disclosed embodiments.

This invention provides Internet based Instant Information Verification. It provides real time automobile liability insurance verification. All data requests preferably require an indirection by using a homing tag lookup in a translation table and network address table. The specific network addresses are considered a security issue and are a restricted element. If a homing tag could be utilized for direct request routing, then someone could create a counterfeit card and have the request route to his or her counterfeit database. This would return a counterfeit valid response. The user subsystem can only be updated and distributed by the administration function, thereby restricting update access to the routing capability. The distribution to end user segments is by secure connection after user validation.

The PVC issued insurance card with security chip may vary. While polyvinyl chloride (PVC) is preferred, other thermoplastics may be used. The term ‘thermoplastic’ usually is applied to synthetics such as polyvinyl chloride, nylons, fluorocarbons, polyethylene, polyurethane, polystyrene, polypropylene, and cellulosic and acrylic resins.

We claim:

1. A system for real time verifying vehicle insurance coverage, the system comprising:
a memory; and
a processing unit coupled to the memory configured to:
store a plurality of identifier associated with a vehicle operator or a vehicle;
store current vehicle insurance coverage information for each of the stored identifiers, wherein the current vehicle insurance coverage information is updated to reflect changes in vehicle insurance coverage for each of the stored identifiers;
receive a query via a communications network requesting verification whether a vehicle operator has current vehicle insurance coverage;
compare the vehicle operator's identifier to the plurality of store identifiers;
verify whether the vehicle operator has current vehicle insurance coverage based on a result of the comparison;
communicate a signal indicative of the result to a source of the query; and
maintain a record of source and frequency from the source of each query requesting verification whether the vehicle operator has current insurance coverage.

2. A system according to claim 1 further comprising a plastic insurance card including a security chip;
wherein insurance card is configured to verify real time vehicle insurance coverage.

3. A system according to claim 2 wherein the plastic insurance card is made of a thermoplastic.

4. A system according to claim 2 wherein the plastic insurance card is made of polyvinyl chloride (PVC).

5. An apparatus according to claim 1 further comprising a plastic insurance card including a bar code:
wherein the insurance card is configured to verify real time vehicle insurance coverage.

6. An apparatus according to claim 1 further comprising a plastic insurance card including a scan code;
wherein the insurance card is configured to verify real time vehicle insurance coverage.

7. A method for determining real time insurance status information for a vehicle, comprising the steps of:
obtaining an identifier for operator or vehicle;
using said identifier to obtain destination data where insurance status information with respect to operator or vehicle is located;
using the data to request the insurance status information from an insurance company; and
receiving a response from the insurance company including, the insurance status information indicating the status of the vehicle.

8. A method according to claim 7 further comprising the steps of:
using a processing unit coupled to a memory configured to:
store a plurality of identifier associated with the vehicle operator or a vehicle to determine the real time insurance status.

9. A method according to claim 8 further comprising the step of:
using a plastic insurance card including a security chip; and
configuring the insurance card to verify real time vehicle insurance coverage.

10. An apparatus for real time verifying vehicle insurance coverage, the system comprising:
a memory; and
a processing unit coupled to the memory configured to:
store a plurality of identifier associated with a vehicle operator or a vehicle;
store current vehicle insurance coverage information for each of the stored identifiers, wherein the current vehicle insurance coverage information is updated to reflect changes in vehicle insurance coverage for each of the stored identifiers;
receive a query via a communications network requesting verification whether a vehicle operator has current vehicle insurance coverage;
compare the vehicle operator's identifier to the plurality of store identifiers;
verify whether the vehicle operator has current vehicle insurance coverage based on a result of the comparison;
communicate a signal indicative of the result to a source of the query; and
maintain a record of source and frequency from the source of each query requesting verification whether the vehicle operator has current insurance coverage.

11. An apparatus according to claim 10 further comprising a plastic insurance card including a security chip;
wherein insurance card is configured to verify real time vehicle insurance coverage.

12. An apparatus according to claim 10 further comprising a plastic insurance card including a bar code;
wherein the insurance card is configured to verify real time vehicle insurance coverage.

13. An apparatus according to claim 10 further comprising a plastic insurance card including a scan code;
wherein the insurance card is configured to verify real time vehicle insurance coverage.
